(19) United States
(12) Patent Application Publication
(10) Pub. No.: US 2022/0147279 A1
(43) Pub. Date: May 12, 2022

(54) HEAT MANAGEMENT SOLID-STATE DATA STORAGE SYSTEM

(71) Applicant: Seagate Technology LLC, Fremont, CA (US)

(72) Inventors: Ryan J. Goss, Prior Lake, MN (US); David W. Claude, Loveland, CO (US)

(21) Appl. No.: 17/520,995

(22) Filed: Nov. 8, 2021

Related U.S. Application Data
(60) Provisional application No. 63/110,461, filed on Nov. 6, 2020.

(51) Int. Cl. G06F 3/06

(52) U.S. Cl. CPC G06F 3/0659; G06F 3/0644; G06F 3/0679; G06F 3/0604

(57) ABSTRACT

A solid-state data storage system that does not have a convective cooling capability can arrange a plurality of memory cells into a plurality of logical namespaces with each logical namespace sequentially written, and entirely erased, as a single unit. The logging of data access activity to the plurality of memory cells with a heat module may determine a workload to at least one namespace. The heat module can create an active heat strategy in view of the at least one namespace workload before an active data access operational policy for a first namespace is altered in response to detection of a workload trigger.

### SUMMARY

The present disclosure is generally directed to managing heat in a solid-state memory, such as, but not limited to, a flash memory in a solid state drive (SSD).

Embodiments of a data storage system that does not have a convective cooling capability arrange a plurality of memory cells into a plurality of logical namespaces with each logical namespace sequentially written, and entirely erased, as a single unit. The logging of data access activity to the plurality of memory cells with a heat module allows a workload to at least one namespace to be determined. The heat module creates an active heat strategy in view of the at least one namespace workload before an active data access operational policy for a first namespace is altered in response to detection of a workload trigger.

A data storage system, in other embodiments, arranges a plurality of memory cells into a plurality of logical namespaces with each logical namespace sequentially written, and entirely erased, as a single unit. The logging of data access activity to the plurality of memory cells with a heat module allows a workload to at least one namespace to be determined. The heat module creates a passive heat strategy in view of the at least one namespace workload before a passive data access operational policy for a first namespace is altered in response to detection of a workload trigger.

Some embodiments of a data storage system arrange a plurality of memory cells into a plurality of logical namespaces with each logical namespace sequentially written, and entirely erased, as a single unit. The logging of data access activity to the plurality of memory cells with a heat module allows a workload to at least one namespace to be determined. The heat module creates an active heat strategy and a passive heat strategy in view of the at least one namespace workload before an active data access operational policy for a first namespace is altered in response to detection of a workload trigger and a passive data access operational policy is altered for a second namespace in response to a predicted workload trigger to the second namespace.

### BRIEF DESCRIPTION OF THE DRAWINGS

FIG. 1 provides a functional block representation of a data storage device in accordance with various embodiments.

FIG. 2 shows aspects of the device of FIG. 1 characterized as a solid state drive (SSD) in accordance with some embodiments.

FIG. 3 shows an arrangement of the flash memory of FIG. 2 in some embodiments.

FIG. 4 illustrates the use of channels to access the dies in FIG. 3 in some embodiments.

FIG. 5 illustrates a map unit (MU) as a data arrangement stored to the flash memory of FIG. 2.

FIG. 6 displays a functional block diagram for a GCU management circuit of the SSD in accordance with some embodiments.

FIG. 7 represents an arrangement of various GCUs and corresponding tables of verified GCUs (TOVGs) for a number of different NVMe sets in some embodiments.

FIG. 8 illustrates an example data set that can be written to the data storage device of FIG. 1 in accordance with assorted embodiments.

FIG. 9 is an example non-standard data set that may occur in the data storage device of FIG. 1 in accordance with various embodiments.

FIG. 10 shows a functional block representation of an example data storage device configured in accordance with some embodiments.

FIG. 11 displays a block representation of portions of an example data storage device arranged in accordance with assorted embodiments.

FIG. 12 shows a block representation of portions of an example data storage device configured in accordance with various embodiments.

FIG. 13 depicts a block representation of portions of example system in which assorted embodiments can be practiced.

FIG. 14 conveys a block representation of portions of an example system operated in accordance with some embodiments.

FIG. 15 depicts a block representation of portions of an example system configured and utilized in accordance with several embodiments.

FIG. 16 depicts a block representation of an example heat module that can be employed in assorted embodiments of a system.

FIG. 17 is a timeline of an example workload procedure that may be conducted in a system in accordance with assorted embodiments.

FIG. 18 depicts a block representation of portions of an example system utilized in accordance with some embodiments.

FIG. 19 is a flowchart of an example memory temperature routine that can be carried out with some embodiments of FIGS. 1-18.

### DETAILED DESCRIPTION

In accordance with assorted embodiments, a data storage system employing solid-state memory without convective cooling means can employ a heat module to provide active and/or passive heat dissipation strategies through the alteration of one or more memory operational policies.

Solid state drives (SSDs) are data storage devices that store user data in non-volatile memory (NVM) made up of an array of solid-state semiconductor memory cells. SSDs usually have an NVM module and a controller. The controller controls the transfer of data between the NVM and a host device. The NVM will usually be NAND flash memory, but other forms of solid-state memory can be used.

A flash memory module may be arranged as a series of dies. A die represents a separate, physical block of semiconductor memory cells. The controller communicates with the dies using a number of channels, or lanes, with each channel connected to a different subset of the dies. Any respective numbers of channels and dies can be used. Groups of dies may be arranged into NVMe sets in accordance with the NVMe (Non-Volatile Memory Express) Standard. This standard enables multiple owners (users) to access and control separate portions of a given SSD (or other memory device).

Metadata is often generated and used to describe and control the data stored to an SSD. The metadata may take the form of one or more map structures that track the locations of data blocks written to various GCUs (garbage collection units), which are sets of erasure blocks that are erased and allocated as a unit. The map structures can include a forward map and a reverse directory, although other forms can be used.

The forward map provides an overall map structure that can be accessed by a controller to service a received host access command (e.g., a write command, a read command, etc.). The forward map may take the form of a two-level map, where a first level of the map maintains the locations of map pages and a second level of the map provides a flash transition layer (FTL) to provide association of logical addresses of the data blocks to physical addresses at which the blocks are stored. Other forms of maps can be used including single level maps and three-or-more level maps, but each generally provides a forward map structure in which pointers may be used to point to each successive block until the most current version is located.

The reverse directory can be written to the various GCUs and provides local data identifying, by logical address, which data blocks are stored in the associated GCU. The reverse directory, also sometimes referred to as a footer, thus provides a physical to logical association for the locally stored blocks. As with the forward map, the reverse directory can take any number of suitable forms. Reverse directories are particularly useful during garbage collection operations, since a reverse directory can be used to determine which data blocks are still current and should be relocated before the associated erasure blocks in the GCU are erased.

SSDs expend a significant amount of resources on maintaining accurate and up-to-date map structures. Nevertheless, it is possible from time to time to have a mismatch between the forward map and the reverse directory for a given GCU. These situations are usually noted at the time of garbage collection. For example, the forward map may indicate that there are X valid data blocks in a given erasure block (EB), but the reverse directory identifies a different number Y valid blocks in the EB. When this type of mismatch occurs, the garbage collection operation may be rescheduled or may take a longer period of time to complete while the system obtains a correct count before proceeding with the recycling operation.

The NVMe specification provides that a storage device should have the ability to provide guaranteed levels of deterministic performance for specified periods of time (deterministic windows, or DWs). To the extent that a garbage collection operation is scheduled during a DW, it is desirable to ensure that the actual time that the garbage collection operation would require to complete is an accurate estimate in order for the system to decide whether and when to carry out the GC operation.

SSDs include a top level controller circuit and a flash (or other semiconductor) memory module. A number of channels, or lanes, are provided to enable communications between the controller and dies within the flash memory. The dies are further subdivided into planes, GCUs, erasure blocks, pages, etc. Groups of dies may be arranged into separate NVMe sets, or namespaces. This allows the various NVMe sets to be concurrently serviced for different owners (users).

In one nonlimiting example, a 4 TB SSD has 128 die connected using 8 channels so that 16 die are connected to each channel. Each die has two planes that support concurrent read or write operations to the same page number (but not necessarily the same erasure blocks, EBs). GCUs nominally are formed using one EB from each of 32 dies. Each page stores 16K of data plus LDPC inner code values. GCU writes are thus formed by writing (nominally) 31 pages of user data, and one page of parity (XOR) data. This will support a loss of a single die. EBs represent the smallest increment of memory that can be erased as a unit, but in practice, garbage collection takes place at the GCU level.

Flash devices can be noisy and thus it is common to write data in the form of code words to individual pages of data. A page may store 16K worth of user payload data, plus some additional number of LDPC (low density parity check) codes, which may be on the order of an additional 5K or so bits. The number and strength of the LDPC codes are used to enable, normally, correct reading back of the payload. Outercode, or parity values, can additionally be written as noted above to correct read errors when the inner code values are insufficient to resolve the error.

Despite the ability to correct errors, the efficient utilization of memory in a solid-state data storage device remains important. With some solid-state memories having a finite lifespan tied to a number of read, write, and erase cycles, such as flash memory, the efficient utilization of memory cells is even more important. The logical division of memory into namespaces has allows object storage that is less rigid than physical division of memory, such as by device, die, plane, page, block, or range of physical block addresses (PBA). The use of namespaces can allow for increased controller customization of where data can be stored, and retrieved. However, simple logical namespaces can generate increased volumes of system processing that can degrade data storage performance.

The evolution of logical memory namespaces has progressed to having zoned namespaces where portions of memory are associated with sequential data writing and collaboration of local memory and host controller for data placement. The use of zoned namespaces can increase data storage efficiency by reducing write amplification, data over-provisioning, and volatile data buffer space consumed during the storage, and retrieval, of data in a memory. Zoned namespaces can be customized to provide increased write performance through streams, but existing zoned namespace configurations and utilizations often suffer from inconsistency, unreliability, and large amounts of produced heat, particularly when relatively large volumes of data are created and stored in solid-state memory that employ multiple physically separate die of memory cells are utilized.

The ability to control heat in a data storage device can be difficult when solid-state memory cells are employed due to the relatively small form-factor of those devices. That is, the reduced space available in a solid-state data storage device, compared to a hard disk drive, limit the space available for heat dissipation and convective cooling components, such as fans, turbines, and blowers. While the lack of convective cooling means in a data storage device can reduce the electrical consumption of the device, the inability to control heat, particularly in high performance and/or data access volume instances, can degrade the accuracy and structural performance of solid-state memory cells while potentially jeopardizing the lifespan of one or more cells. Accordingly, assorted embodiments are directed at utilizing solid-state memory cells with intelligent operational policies that adapt to control heat in a data storage device despite the device not having a convective cooling capability.

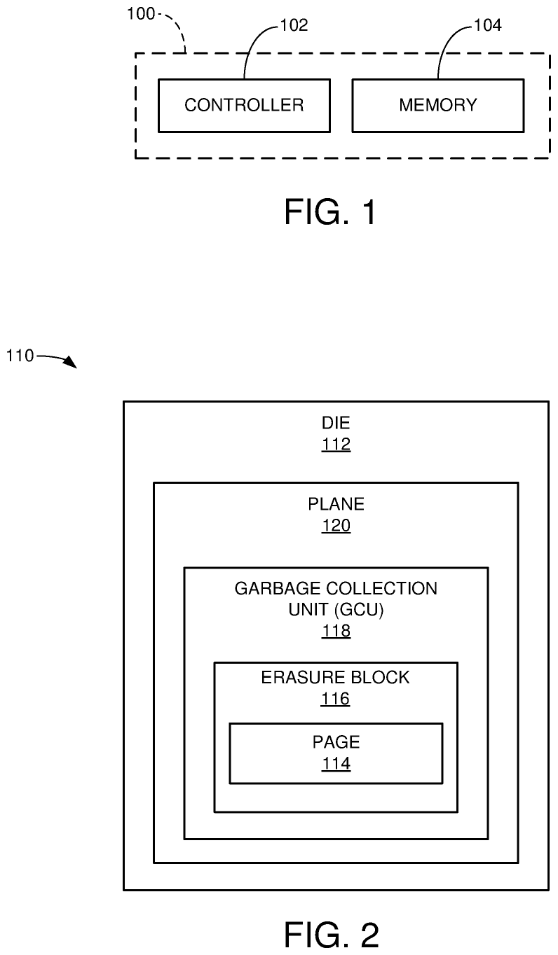

These and other features may be practiced in a variety of different data storage devices, but various embodiments conduct intelligent heat dissipation in the example data storage device 100 shown as a simplified block representation in FIG. 1. The device 100 has a controller 102 and a memory module 104. The controller block 102 represents a hardware-based and/or programmable processor-based circuit configured to provide top level communication and control functions. The memory module 104 includes solid state non-volatile memory (NVM) for the storage of user data from one or more host devices 106, such as other data storage devices, network server, network node, or remote controller.

FIG. 2 shows a block representation of portions of an example memory 110 arranged in accordance with some embodiments. A memory die 112 can be configured with any solid-state memory cells, such as flash, resistive, phase change, and spin-torque memory, without limitation. The smallest unit of memory that can be accessed at a time is referred to as a page 114. A page 114 may be formed using a number of solid-state memory cells that share a common word line, bit line, or source line. The storage size of a page 114 can vary; current generation flash memory pages can store, in some cases, 16 KB (16,384 bytes) of user data.

A number of pages are integrated into an erasure block 116, which represents the smallest grouping of memory cells that can be concurrently erased in a NAND flash memory. A number of erasure blocks 116 can be arranged into a garbage collection unit (GCU) 118, which may utilize erasure blocks across different dies 112, as explained below. GCUs 118 can be allocated for the storage of data. Once a sufficient amount of the stored data is determined to be stale (e.g., no longer the most current version), a garbage collection operation can be carried out to recycle the GCU 118. This includes identifying and relocating the current version data to a new location, followed by an erasure operation to reset the memory cells. The GCU 118 may then be returned to an allocation pool for subsequent allocation to begin storing new user data.

Each die 112 may include a plurality of planes 120. Examples include two planes per die, four planes per die, etc. although other arrangements can be used. Generally, a plane is a subdivision of the die 112 arranged with separate read/write/erase circuitry such that a given type of access operation (such as a write operation, etc.) can be carried out simultaneously by each of the planes to a common page address within the respective planes.

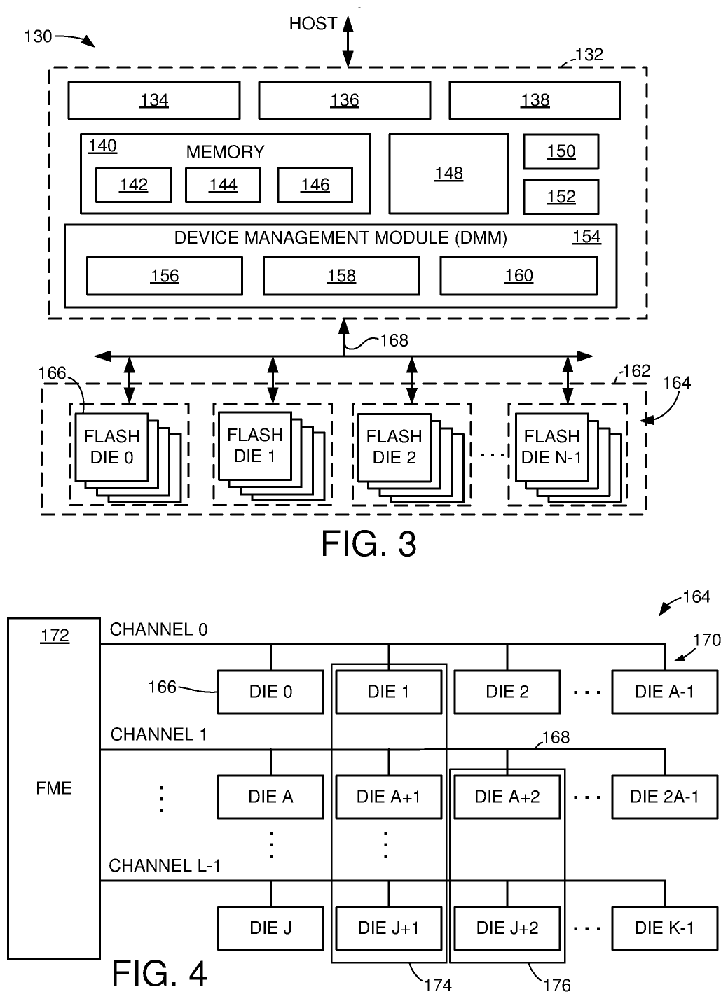

FIG. 3 depicts portions of an example data storage device 130 generally corresponding to the device 100 in FIG. 1. The device 130 is configured as a solid state drive (SSD) that communicates with one or more host devices via one or more Peripheral Component Interface Express (PCIe) ports, although other configurations can be used. The NVM is contemplated as comprising NAND flash memory, although other forms of solid state non-volatile memory can be used.

In at least some embodiments, the SSD operates in accordance with the NVMe (Non-Volatile Memory Express) Standard, which enables different users to allocate NVMe sets (die sets) for use in the storage of data. Each NVMe set may form a portion of an NVMe Namespace that may span multiple SSDs or be contained within a single SSD.

The SSD 130 includes a controller circuit 132 with a front end controller 134, a core controller 136 and a back end controller 138. The front end controller 134 performs host I/F functions, the back end controller 138 directs data transfers with the memory module 134 and the core controller 136 provides top level control for the device.

Each controller 134, 136 and 138 includes a separate programmable processor with associated programming (e.g., firmware, FW) in a suitable memory location, as well as various hardware elements to execute data management and transfer functions. This is merely illustrative of one embodiment; in other embodiments, a single programmable processor (or less/more than three programmable processors) can be configured to carry out each of the front end, core and back end processes using associated FW in a suitable memory location. A pure hardware based controller configuration can also be used. The various controllers may be integrated into a single system on chip (SOC) integrated circuit device, or may be distributed among various discrete devices as required.

A controller memory 140 represents various forms of volatile and/or non-volatile memory (e.g., SRAM, DDR DRAM, flash, etc.) utilized as local memory by the controller 132. Various data structures and data sets may be stored by the memory including one or more map structures 142, one or more caches 144 for map data and other control information, and one or more data buffers 146 for the temporary storage of host (user) data during data transfers.

A non-processor based hardware assist circuit 148 may enable the offloading of certain memory management tasks by one or more of the controllers as required. The hardware circuit 148 does not utilize a programmable processor, but instead uses various forms of hardwired logic circuitry such as application specific integrated circuits (ASICs), gate logic circuits, field programmable gate arrays (FPGAs), etc.

Additional functional blocks can be realized in hardware and/or firmware in the controller 132, such as a data compression block 150 and an encryption block 152. The data compression block 150 applies lossless data compression to input data sets during write operations, and subsequently provides data de-compression during read operations. The encryption block 152 provides any number of cryptographic functions to input data including encryption, hashes, decompression, etc.

A device management module (DMM) 154 supports back end processing operations and may include an outer code engine circuit 156 to generate outer code, a device I/F logic circuit 158 and a low density parity check (LDPC) circuit 160 configured to generate LDPC codes as part of the error detection and correction strategy used to protect the data stored by the by the SSD 130.

A memory module 162 corresponds to the memory 104 in FIG. 1 and includes a non-volatile memory (NVM) in the form of a flash memory 164 distributed across a plural number N of flash memory dies 166. Rudimentary flash memory control electronics (not separately shown in FIG. 3) may be provisioned on each die 166 to facilitate parallel data transfer operations via one or more channels (lanes) 168.

FIG. 4 shows further aspects of the flash memory 164 arranged in accordance with some embodiments. A total number K dies 166 are provided and arranged into physical die groups 170. Each die group 170 is connected to a separate channel 168 using a total number of L channels. In one example, K is set to 128 dies, L is set to 8 channels, and each physical die group has 16 dies. As noted above, a single die within each physical die group can be accessed at a time using the associated channel. A flash memory electronics (FME) circuit 172 of the flash memory 164 controls each of the channels 168 to transfer data to and from the dies 166.

In some embodiments, the various dies are arranged into one or more NVMe sets. An NVMe set represents a portion of the storage capacity of the SSD that is allocated for use by a particular host (user/owner). NVMe sets are usually established with a granularity at the die level, so that some percentage of the total available dies 166 will be allocated for incorporation into a given NVMe set.

A first example NVMe set is denoted at 174 in FIG. 4. This first set 174 uses a single die 166 from each of the different channels 168. This arrangement provides fast performance during the servicing of data transfer commands for the set since all eight channels 168 are used to transfer the associated data. A limitation with this approach is that if the set 174 is being serviced, no other NVMe sets can be serviced during that time interval. While the set 174 only uses a single die from each channel, the set could also be configured to use multiple dies from each channel, such as 16 dies/channel, 32 dies/channel, etc.

A second example NVMe set is denoted at 176 in FIG. 4. This set uses dies 166 from less than all of the available channels 168. This arrangement provides relatively slower overall performance during data transfers as compared to the set 174, since for a given size of data transfer, the data will be transferred using fewer channels. However, this arrangement advantageously allows the SSD to service multiple NVMe sets at the same time, provided the sets do not share the same (e.g., an overlapping) channel 168.

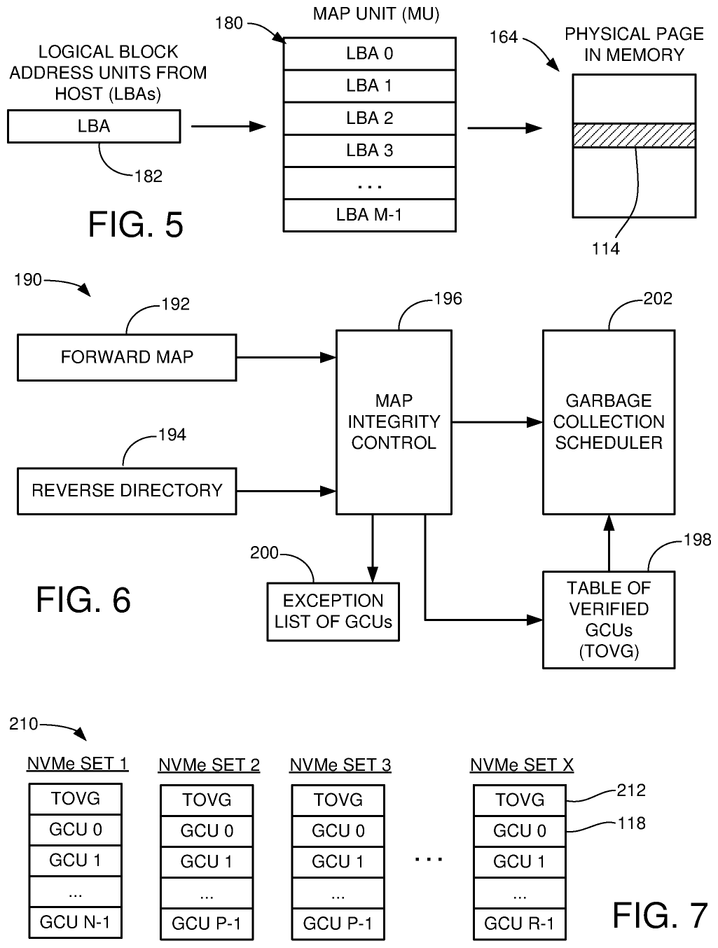

FIG. 5 illustrates a manner in which data may be stored to a flash memory 164. Map units (MUs) 180 represent fixed sized blocks of data that are made up of one or more user logical block address units (LBAs) 182 supplied by the host. Without limitation, the LBAs 182 may have a first nominal size, such as 512 bytes (B), 1024 B (1 KB), etc., and the MUs 180 may have a second nominal size, such as 4096 B (4 KB), etc. The application of data compression may cause each MU to have a smaller size in terms of actual bits written to the flash memory 164.

The MUs 180 are arranged into the aforementioned pages 114 (FIG. 2) which are written to the memory 164. In the present example, using an MU size of 4 KB, then nominally four (4) MUs may be written to each page. Other configurations can be used. To enhance data density, multiple pages worth of data may be written to the same flash memory cells connected to a common control line (e.g., word line) using multi-bit writing techniques; MLCs (multi-level cells) write two bits per cell, TLCs (three-level cells) write three bits per cell; XLCs (four level cells) write four bits per cell, etc.

Data stored by an SSD are often managed using metadata. The metadata provide map structures to track the locations of various data blocks (e.g., MUAs 180) to enable the SSD 130 to locate the physical location of existing data. For example, during the servicing of a read command it is generally necessary to locate the physical address within the flash memory 166 at which the most current version of a requested block (e.g., LBA) is stored, so that the controller can schedule and execute a read operation to return the requested data to the host. During the servicing of a write command, new data are written to a new location, but it is still necessary to locate the previous data blocks sharing the same logical address as the newly written block so that the metadata can be updated to mark the previous version of the block as stale and to provide a forward pointer or other information to indicate the new location for the most current version of the data block.

FIG. 6 shows a functional block diagram for a GCU management circuit 190 of the SSD 130 in accordance with some embodiments. The circuit 190 may form a portion of the controller 132 and may be realized using hardware circuitry and/or one or more programmable processor circuits with associated firmware in memory. The circuit 190 includes the use of a forward map 192 and a reverse directory 194. As noted above, the forward map and reverse directory are metadata data structures that describe the locations of the data blocks in the flash memory 164. During the servicing of host data transfer operations, as well as other operations, the respective portions of these data structures are located in the flash memory or other non-volatile memory location and copied to local memory 140 (see e.g., FIG. 3).

The forward map 192 provides a flash transition layer (FTL) to generally provide a correlation between the logical addresses of various blocks (e.g., MUAs) and the physical addresses at which the various blocks are stored (e.g., NVMe set, die, plane, GCU, EB, page, bit offset, etc.). The contents of the forward map 192 may be stored in specially configured and designated GCUs in each NVMe set.

The reverse directory 194 provides a physical address to logical address correlation. The reverse directory contents may be written as part of the data writing process to each GCU, such as in the form of a header or footer along with the data being written. Generally, the reverse directory provides an updated indication of how many of the data blocks (e.g., MUAs) are valid (e.g., represent the most current version of the associated data).

The circuit 190 further includes a map integrity control circuit 196. As explained below, this control circuit 196 generally operates at selected times to recall and compare, for a given GCU, the forward map data and the reverse directory data. This evaluation step includes processing to determine if both metadata structures indicate the same number and identify of the valid data blocks in the GCU.

If the respective forward map and reverse directory match, the GCU is added to a list of verified GCUs in a data structure referred to as a table of verified GCUs, or TOVG 198. The table can take any suitable form and can include a number of entries, with one entry for each GCU. Each entry can list the GCU as well as other suitable and useful information, such as but not limited to a time stamp at which the evaluation took place, the total number of valid data blocks that were determined to be present at the time of validation, a listing of the actual valid blocks, etc.

Should the control circuit 196 find a mismatch between the forward map 192 and the reverse directory 194 for a given GCU, the control circuit 196 can further operate to perform a detailed evaluation to correct the mismatch. This may include replaying other journals or other data structures to trace the history of those data blocks found to be mismatched. The level of evaluation required will depend on the extent of the mismatch between the respective metadata structures.

For example, if the forward map 192 indicates that there should be some number X valid blocks in the selected GCU, such as 12 valid blocks, but the reverse directory 194 indicates that there are only Y valid blocks, such as 11 valid blocks, and the 11 valid blocks indicated by the reverse directory 194 are indicated as valid by the forward map, then the focus can be upon the remaining one block that is valid according to the forward map but invalid according to the reverse directory. Other mismatch scenarios are envisioned.

The mismatches can arise due to a variety of factors such as incomplete writes, unexpected power surges or disruptions that prevent a full writing of the state of the system, etc. Regardless, the control circuit can expend the resources as available to proactively update the metadata. In some embodiments, an exception list 200 may be formed as a data structure in memory of GCUs that have been found to require further evaluation. In this way, the GCUs can be evaluated later at an appropriate time for resolution, after which the corrected GCUs can be placed on the verified list in the TOVG 198.

It will be noted that the foregoing operation of the control circuit 196 in evaluating GCUs does not take place once a garbage collection operation has been scheduled; instead, this is a proactive operation that is carried out prior to the scheduling of a garbage collection operation. In some cases, GCUs that are approaching the time at which a garbage collection operation may be suitable, such as after the GCU has been filled with data and/or has reached a certain aging limit, etc., may be selected for evaluation on the basis that it can be expected that a garbage collection operation may be necessary in the relatively near future.

FIG. 6 further shows the GCU management circuit 190 to include a garbage collection scheduler circuit 202. This circuit 202 generally operates once it is appropriate to consider performing a garbage collection operation, at which point the circuit 202 selects from among the available verified GCUs from the table 198. In some cases, the circuit 202 may generate a time of completion estimate to complete the garbage collection operation based on the size of the GCU, the amount of data to be relocated, etc.

As will be appreciated, a garbage collection operation can include accessing the forward map and/or reverse directory 192, 194 to identify the still valid data blocks, the reading out and temporary storage of such blocks in a local buffer memory, the writing of the blocks to a new location such as in a different GCU, the application of an erasure operation to erase each of the erasure blocks in the GCU, the updating of program/erase count metadata to indicate the most recent erasure cycle, and the placement of the reset GCU into an allocation pool awaiting subsequent allocation and use for the storage of new data sets.

FIG. 7 shows a number of NVMe sets 210 that may be arranged across the SSD 130 in some embodiments. Each set 210 may have the same nominal data storage capacity (e.g., the same number of allocated dies, etc.), or each may have a different storage capacity. The storage capacity of each NVMe set 210 is arranged into a number of GCUs 118 as shown. In addition, a separate TOVG (table of verified GCUs) 212 may be maintained by and in each NVMe set 210 to show the status of the respective GCUs. From this, each time that it becomes desirable to schedule a garbage collection operation, such as to free up new available memory for a given set, the table 212 can be consulted to select a GCU that, with a high degree of probability, can be subjected to an efficient garbage collection operation without any unexpected delays due to mismatches in the metadata (forward map and reverse directory).

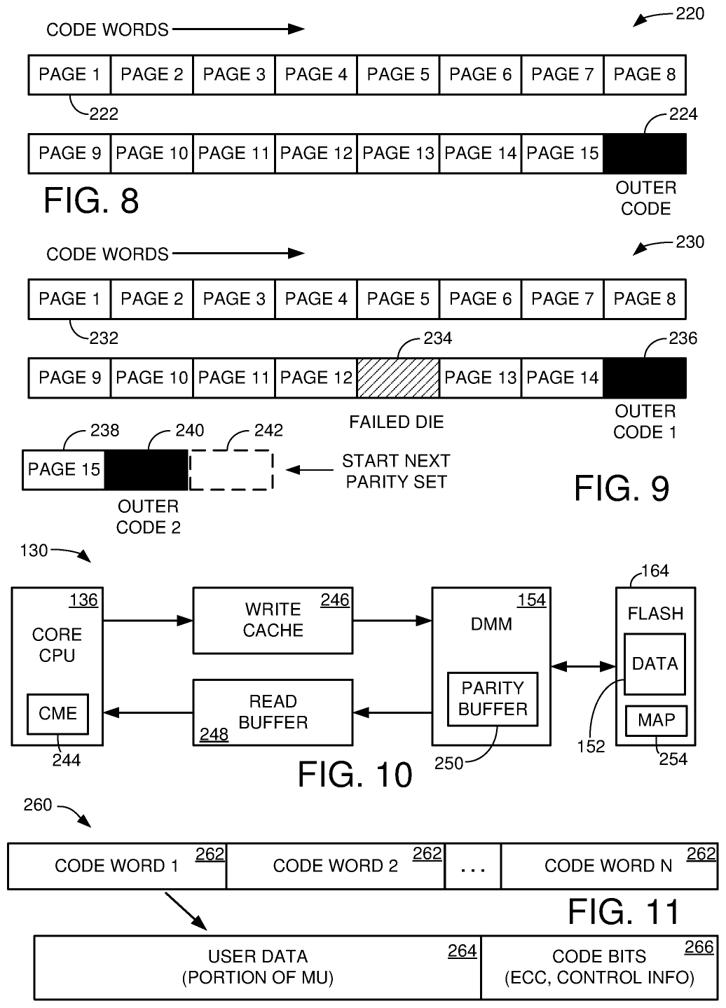

FIG. 8 illustrates a manner in which a parity data set 220 can be written to a selected GCU 118 in the flash memory 164 in accordance with some embodiments. In this example, it is contemplated that the selected GCU 118 is formed from sixteen (16) erasure blocks 116, with each of the erasure blocks disposed on a different die 166. Other sizes can be used as desired.

In FIG. 8, the parity data set has fifteen (15) user data pages 222, with each user data page, or payload, written to a different one of the dies. More generally, the GCU has N erasure blocks on a corresponding N dies, and payloads 222 are written to N-1 of the dies. The Nth die receives an outer code (parity value), which is represented at 224. As mentioned above, the outer code may be generated by summing the page data in a buffer using an XOR function. Because the parity data set 220 has data boundaries that nominally match the GCU boundaries, the parity data set in FIG. 8 is referred to as a standard parity data set since the data matches the available memory.

FIG. 9 shows an example non-standard parity data set 230. The parity data set 230 is the same size as the parity data set 220 in FIG. 8 in that, as before, the parity data set 230 has a total of fifteen (15) pages/payloads 232. However, one of the dies 166 has experienced a failure, as indicated at 234, so that the GCU only spans 15 dies.

Accordingly, the controller circuit 132 (FIG. 3) operates to write a full set of the available pages, which in this case is Page 1 to Page 14, through the available dies. This is followed by the writing of a first outer code (parity value) in the Nth location, as shown at 236, which protects the payloads (Page 1 to Page 14) written during this first pass through the available dies.

A leftover payload 238 (Page 15) is written to the next available page in the first die (such as adjacent Page 1). This leftover payload is referred to as a runt or runt data, and represents the remainder after an integer number of passes have been made through the available dies. Once all of the leftover payloads have been written, a second outer code (parity value) is written in the next available die, as shown at 240. This second outer code is disposed in the same die as, and is adjacent to, the Page 2 payload.

In this way, when leftover (runt) payload sets remain, these are written to as many additional dies as are required, followed by the writing of a final parity value to cover the runts. Map data may be generated to note the non-standard outer code arrangement. This provides a parity data set with a parity value to protect each pass through the dies, plus another parity value to cover the remainder.

While FIG. 9 shows the non-standard parity data set has arisen due to a non-standard sized available memory (e.g., due to the die failure at 234), other non-standard parity data sets can arise based on other factors. For example, a particular data set to be written to a given NVMe set may make up a total number of MUs that do not align with the GCU boundaries. In another case, data compression or other processing may result in a non-standard sized parity data set. It will be appreciated that if a given GCU has N dies, then a non-standard sized data set will have a total number M payloads (or portions thereof) that are not divisible by N without a remainder. The remainder could be any value from one extra payload up to N-1 extra payloads. Regardless, each pass through the dies will be parity protected, irrespective of the overall length of the parity data set.

Once a non-standard parity set is written, map data may be generated and stored to indicate the fact that the parity data set is of non-standard length. Information may be stored in the map data such as how much longer the data set is in terms of additional pages in the remainder, the location of the last parity value (e.g., 240), etc. To maximize data density, the controller may operate to initiate the writing of the next parity data set at the next available page on the next die in the sequence, as shown at 242 in FIG. 9.

FIG. 10 shows a functional block representation of additional aspects of the SSD 130. The core CPU 136 from FIG. 3 is shown in conjunction with a code management engine (CME) 244 that can be used to manage the generation of the respective code words and outer code parity values for both standard and non-standard parity data sets During write operations, input write data from the associated host are received and processed to form MUs 180 (FIG. 5) which are placed into a non-volatile write cache 246 which may be flash memory or other form(s) of non-volatile memory. The MUs are transferred to the DMM circuit 154 for writing to the flash memory 164 in the form of code words that contain user data, inner code, and outer code. During read operations, one or more pages of data are retrieved to a volatile read buffer 248 for processing prior to transfer to the host.

The CME 244 determines the appropriate inner and outer code rates for the data generated and stored to memory. In some embodiments, the DMM circuit 154 may generate both the inner and outer codes. In other embodiments, the DMM circuit 154 generates the inner codes (see e.g., LDPC circuit 160 in FIG. 3) and the core CPU 136 generates the outer code words. In still other embodiments, the same processor/controller circuit generates both forms of code words. Other arrangements can be used as well. The CME 244 establishes appropriate code rates for both types of code words.

During generation of the outer codes, a parity buffer 250 may be used to successively XOR each payload being written during each pass through the dies. Both payload data 252 and map data 254 will be stored to data locations in flash 164.

FIG. 11 is a block representation of portions of an example data storage device 260 in which data is arranged into a plurality of code words 262 that can efficiently be stored, and retrieved, from one or more SSD storage destinations. A page 150 of data may comprise a number of consecutive, or non-consecutive, code words 262 organized to effectively fit in the available space of an SSD.

As shown, a code word 262 can consist of user data 264 and inner code 266 generated to complement the user data 264, such as by the LDPC circuitry 138. The inner code 266 can provide a diverse variety of capabilities, such as error correction via error correction code (ECC), data status, data offset, and other data control information. The combination of user data 264 and inner code 266 together in a code word 262 allows for efficient analysis, verification, and correction (if necessary) of errors in reading, or writing, the user data 264 to/from memory. However, the inner code 266 may be insufficient, in some cases, to overcome and/or correct errors associated with storage of the code word 262. Hence, various embodiments generate outer code that provides higher-level data analysis and correction in complementary fashion to the inner code 266.

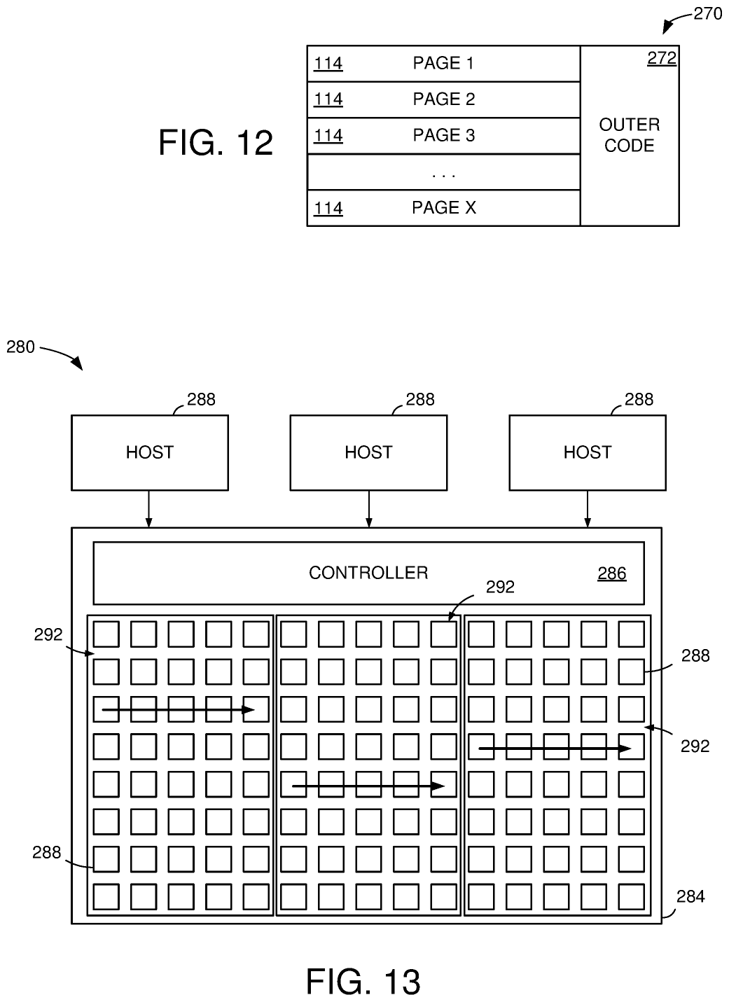

FIG. 12 conveys a block representation of a portion of an example data storage device 270 where pages 150 of code words 262 are stored in combination with outer code 272 in accordance with some embodiments. The outer code 272 may be associated with one or more pages 150 of code words to provide data that describes the constituent code words 262 and allows for verification and correction of the accuracy, and reliability, of the user data of the respective code words 262.

It is contemplated that the outer code 272 can operate to correct errors and faults that occur during the reading, or writing, of the code words 262. Such corrective function of outer code 272 allows user data to be retrieved despite encountered errors/faults that were uncorrectable by inner code 266. In some embodiments, a probation counter for the user data and/or the physical address of memory where the user data 264 is stored is maintained in the inner code 266, outer code 272, or elsewhere in memory to allow a physical address and/or user data to be monitored in real-time with simple polling of the probation counter.

The ability to correct and recover from encountered error during data access operations to a memory provides additional longevity and reliability for a memory and the data stored therein. However, this ability comes at a relatively high system resource price as processing, storage capacity, and time are expended to correct errors and recover data. The use of such system resources can jeopardize the data storage and retrieval performance for some, or all, of a distributed data storage system. Regardless of the sophistication, efficiency, or accuracy of error/failure recovery in a data storage device, the inefficient retrieval of stored data can jeopardize the performance of a data storage device as well as reduce the operational lifespan of the memory constituent in the device.

FIG. 13 depicts portions of an example data system 280 arranged and utilized in accordance with assorted embodiments. The system 280 shows how multiple separate hosts 282 are connected to a data storage device 284 that employs a local drive controller 286 to direct data accesses in one or more memory cells 288. It is noted that the data storage system 280 can employ any number of hosts 282 connected to one or more data storage devices 284 via any number of wired and/or wireless connections.

The drive controller 286 can organize the assorted memory cells 288 into various logical namespaces 290 that can span any physical memory cell configuration, such as one or more platters, die, planes, or pages. The various namespaces 290 can provide selective writing of data, which can be utilized for dedicated streaming of data from one or more hosts, wear-leveling of data across amongst available memory cells 288, and reduced data access latency in some situations. However, the generation and maintenance of namespaces 290 can increase write amplification and mapping cache needs in addition to greater volumes of over-provisioning space.

Thus, namespaces 290 can be arranged in zones, as shown, that involve protocol to sequentially write data from the beginning data block address of each zone 290 without the ability to overwrite or erase anything but an entire zone 290, as illustrated by arrows. The logical zoned namespaces 290 provide the ability to allow a host 282 direct access to portions of memory, which can reduce latency while increasing data throughput and cost efficiency. Compared to non-zoned namespaces, zoned namespaces 290 allow for separate host workloads with less over-provisioning and write amplification. Yet, the treatment of a zoned namespace 290 as a collective data unit that must be sequentially written and only erased as a whole increases front-end processing and buffer space for data accesses, mapping, and organization.

The logical organization of memory cells 288 into namespaces 290, particularly zoned namespaces 290, can create processing and implementation difficulties when the namespace 290 spans physical block addresses of cells 288 located in separate locations, such as different data storage devices or die of a single data storage device. For instance, the erasing of the entirety of a zoned namespace 290 spanning separate physical block addresses can involve different channels, memory cell 288 maintenance operations, and delays compared to a namespace 290 located in a single physical memory, such as a single die or plane of cells 288. Such increased activity can be operationally inefficient and produce volumes of heat that can temporarily or permanently degrade the data storage accuracy, speed, and life of solid-state memory cells.

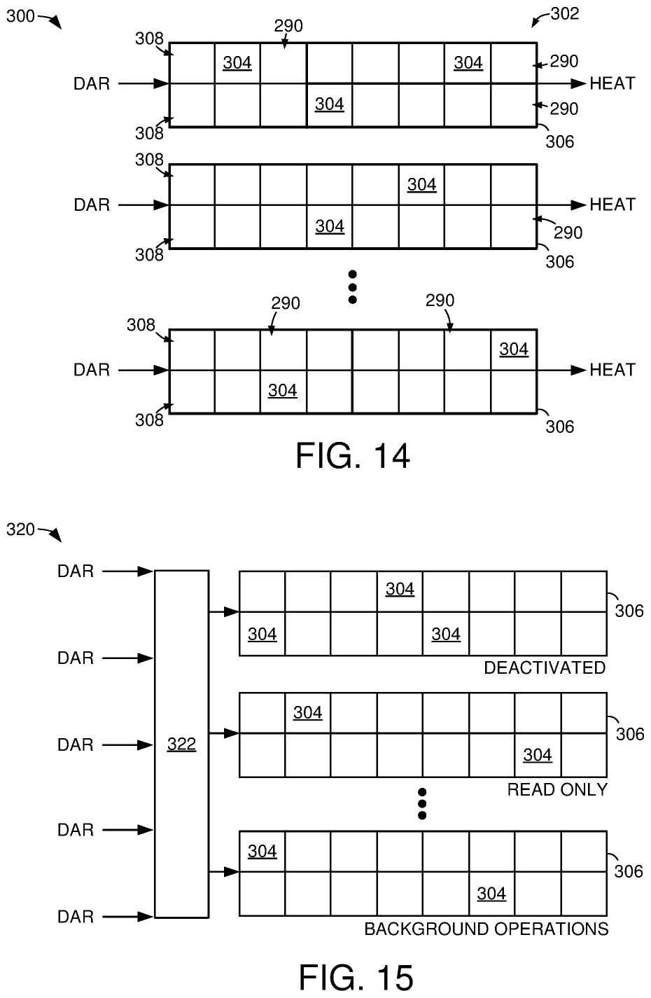

FIG. 14 conveys a block representation of portions of an example data storage system 300 in which assorted embodiments can be practiced. The system 300 can be utilized with any number of data storage devices that respectively employ one or more memories 302 comprising multiple solid-state memory cells 304 that are physically divided into die 306 and planes 308 while being logically divided into zoned namespaces 290.

As shown, servicing data access requests (DAR) to the respective die 306 generates heat that accumulate and degrade data access performance if not dissipated. While moving air conventionally dissipates generated heat and allows the memory cells 304 to operate with minimal operational degradation, modern solid-state memories are utilized without convective cooling capabilities. The resulting accumulation of heat proximal solid-state memory cells 308 can alter how solid-state cells operate, which degrades data access performance and potential, and alter the failure rate of cells, which degrades the lifespan and reliability of a die 306 and system 300. Hence, various embodiments dissipate heat by altering operational policies that dictate how data accesses are carried out.

FIG. 15 depicts a block representation of portions of an example data storage system 320 in which operational heat dissipation is conducted in accordance with some embodiments. A heat module 322 is employed to evaluate activity to various solid-state memory cells 304 that are physically configured in planes 308 and die 306 while being logically organized in one or more groups, such as namespaces and garbage collection units (GCU).

In response to memory cell 304 activity that generates heat, the heat module 322 can conduct one or more cooling operations. As a non-limiting example, the heat module 322 may deactivate a memory die 306 to allow heat to dissipate. Another example cooling operation involves altering operation of a memory plane 308, namespace, and/or die 306 to conduct a specific type of data accesses, such as data reads or background memory cell actions, that produce less heat than data writes. The ability to react to heat-generating data access activity in the solid-state memory cells 304 allows the heat module 322 to preserve the accuracy, reliability, and performance capabilities of the memory. Despite the relatively simple reactions to generated heat, it is contemplated that the heat module 322 conducts sophisticated and intelligent actions that reactively, or proactively, manages the generation of heat in a solid-state memory.

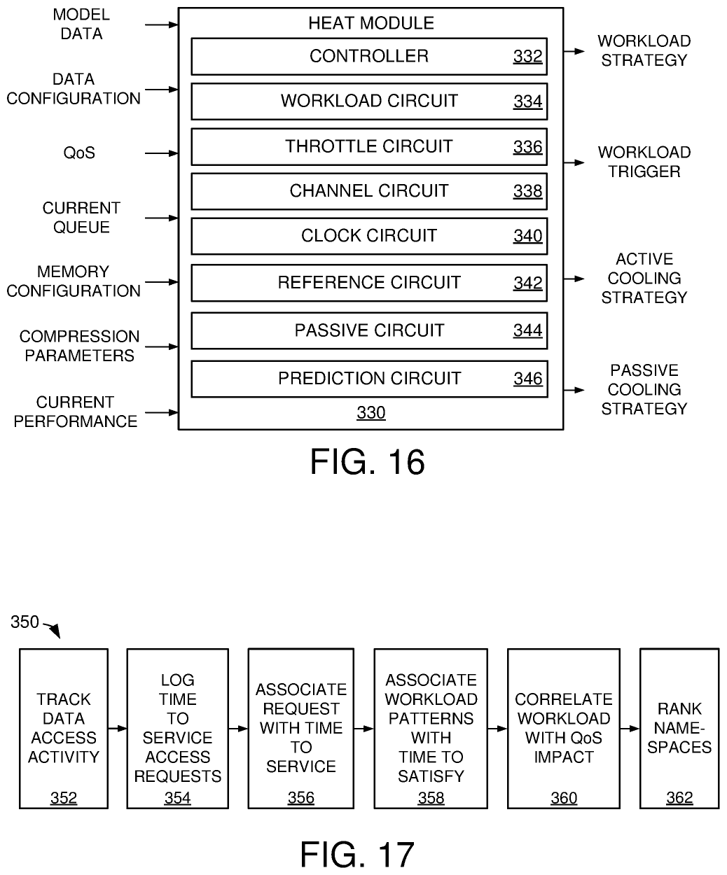

FIG. 16 depicts a block representation of an example heat module 330 that can be employed in a data storage system in accordance with assorted embodiments to schedule and carry out intelligent heat dissipation despite a lack of any air moving components in a device utilizing solid-state memory cells. The module 330 can utilize one or more controllers 332 to translate a variety of input information into at least a workload detection strategy, a workload trigger, active heat dissipation strategy, and passive heat dissipation strategy that can be selectively, and concurrently, conducted to provide memory in view of dynamic data access workloads. The module controller 332 may be a standalone circuit, such as a microprocessor or other programmable circuitry, resident anywhere in a data system, such as in a standalone node, network node, host, or data storage device.

Regardless of where a controller 332, and module 330, is located in a data system, the data access activity to one or more memories can be monitored and logged along with the current memory configuration, security protocol, quality of service criteria, and data locations. The module controller 332 can input past logged information, such as error rate, data access latency, location of stale data, and garbage collection activity. While current and past information about the data system in which the module 330 is resident can be procured, the controller 332 may additionally refer to one or more data models pertaining to other data storage systems, memories, or host access activity.

While not limiting, the namespace module 330 can input assorted current and past logged conditions for one or more memories of a data storage system. For instance, the current physical block addresses of various calibration groups, the addresses of past data access errors and failures, the current physical and logical configurations of memory cells, and the pending data operations to the memory cells can be utilized individually, and collectively, to understand current namespace configurations and performance as well as future cell arrangements for namespace optimization.

The module controller 332 can operate alone to generate and maintain the various strategies to control current and future namespace workloads, configurations, and data access operations. However, some embodiments employ assorted circuitry to aid the module controller 332 in efficiently creating, altering, and executing the respective output strategies. A workload circuit 334 can assist the module controller 332 in translating the various input information into a workload strategy that has one or more triggers that correspond with a namespace operational policy change in order to mitigate, or eliminate namespace data access performance degradation.

Although not required or limiting, the workload circuit 334 can generate and maintain multiple workload strategies for separate namespaces and/or memory die which allows for concurrent optimization of the respective memory cells through the execution of different operational policy changes prescribed by the respective namespace strategies in response to detected, or predicted, activity that meets a predetermined workload trigger. For instance, a first namespace may have a first workload strategy generated by the workload circuit 334 that prompts the execution of a first set of operational policy changes, namespace operation, data writing, indexing, compression, journaling, and/or GCU operation, in response to a first trigger being met while a second namespace of a data storage device has a different workload strategy and triggers that prompt a different set of operational policy changes customized to the second namespace based on the workload to that namespace.

In order to induce memory cooling without moving air or relatively large heatsinks, the heat module 330 can generate, maintain, and selectively execute an active cooling strategy and a passive cooling strategy based on past, current, pending, and model data pertaining to memory cell activity. It is noted that the heat module 330 may deactivate portions of a memory to induce cooling. However, such deactivation can degrade overall memory performance as startup, initialization, and mapping can occupy system resources and time that would otherwise be utilized servicing data access requests and background memory operations. Hence, various embodiments of the passive and active cooling strategies maintain all memory cells in an activated state and ready for access by the module controller 332.

The active cooling strategy can be supported by a throttle circuit 336 of the heat module 330 that prescribes actions that deliberately and artificially slow the execution of memory cell activity in order to mitigate the generation of heat and dissipate existing heat proximal a memory die. The throttle circuit 336 may prescribe one or more temporal delays to be inserted in between data access to induce a reduction in heat production from memory cell activity. Another, non-limiting, action prescribed to the active cooling strategy by the throttle circuit 336 involves reorganizing one or more pending data accesses to prioritize slower activity, such as data writes or error recovery operations. It is contemplated that the throttle circuit 336 prescribes changes to the physical memory destination for data to memory cells that have lower peak and/or average data access speed, such as different GCU, namespace, die, or plane.

The throttle circuit 336 can prescribe changes to the electrical operation of memory to induce slower data access performance. For instance, reduced data access voltage can be utilized for some data accesses while slower signal pathways can be utilized for other data accesses to temporarily reduce the performance, speed, and generated heat from selected portions of memory. The active cooling strategy can involve selective alteration of how data is stored or read, as directed by the throttle circuit 336. For example, the throttle circuit 336 can change random reads and/or writes to sequential reads and/or writes, or vice versa, to slow the generation of heat from selected portions of memory.

Through the reactive and/or proactive actions provided to the active cooling strategy from the throttle circuit 336, the heat module 330 can provide an intelligent balance of data access performance for a memory compared to power and heat. Some embodiments of the active cooling strategy maintain overall system performance while slowing activity and heat generation through execution of actions prescribed by the throttle circuit 336 by increasing the real-time performance of memory not producing relatively high volumes of heat. That is, the active cooling strategy can prescribe actions that induce some memory cells to perform greater than average data access speed and other actions to different memory cells to induce lower than average data access speed performance.

A channel circuit 338 can provide one or more actions to the active cooling strategy that manipulates how much heat memory cells produce by altering how signal pathways are utilized. Some actions of the active cooling strategy prescribed by the channel circuit 338 can selectively employ a slower signal pathway, such as a bus, interface, or channel, instead of a faster signal pathway. Other, non-limiting, actions can involve the overloading of pending activity to a channel to effectively slow the execution of that activity, which throttles the activity and reduces the generation of heat by some memory cells.

In some embodiments of an active cooling strategy, a clock circuit 340 provides alterations to clock and/or bus speeds that reduce memory cell activity speed for selected memory cells. Sophisticated clock/bus speed manipulation through execution of the active cooling strategy can slow memory cell performance to some memory cells while increasing performance to other memory cells that are not physically proximal to high volumes of heat. As such, the active cooling strategy can balance slower clock/bus speeds with faster clock/bus speeds to mitigate heat accumulation around some memory cells without degrading overall data access performance for a memory.

The heat module 330 can employ a reference circuit 342 to prescribe one or more changes to memory cell read and/or write voltages to reduce the generation of heat. That is, the active cooling strategy can involve changes to the reference voltage set to a memory cell and/or changes to the voltage used to read and/or write a memory cell. In practice, actions prescribed by the reference circuit 342 can offset existing reference voltage values for selected cells to lower the voltage used to read and/or write data without actually changing the reference voltage set to a memory cell. For instance, the demarcation between logical states in a selected memory cell may be altered as part of an active cooling strategy so that lower read voltages can be used to discover what logical value is stored. Another example involves lowering the voltage used to write data.

While the active cooling strategy can be executed at any time, a passive cooling strategy can be executed on portions of a memory. A passive circuit 344 can prescribe one or more alterations to the data stored in memory to change memory cell operation and lower the volume of heat generated. It is noted that the difference between active cooling and passive cooling involves actions conducted during data reading/writing compared to actions conducted without a data write operation or a data read operation. As such, the passive circuit 344 can prescribe altering the error correction stored, or executed, for a memory cell. Another example passive strategy action can involve reducing the refresh rate for memory cells without a corresponding data read request.

The generation and maintenance of the respective cooling strategies prior to executing cooling actions that alter the operation of one or more memory cells allows for efficient, customized cooling operations catered to the workload of a namespace. In some embodiments, the workload circuit 334 can generate and maintain one or more logs of data access activity and memory operations that can be pertinent to identifying current, pending, and future workloads to various zoned namespaces. For instance, the data access frequency (temperature) for an memory cell can initially be logged by the controller 332 before altering the granularity of the temperature tracking to a per-die or per-plane basis, as directed by at least one predetermined strategy.

Another non-limiting example logs data access type and frequency to identify if a namespace is hot or cold with respect to host data access requests, which allows the module controller 332 to assign a workload evaluation for a namespace that represents how much activity a namespace is experiencing. It is noted that the module controller 332 may determine various types of workload for assorted data storage system namespaces, such as volume of data accesses over time, amount of processing overhead consumed by accesses to a namespace, or volume of available namespace memory occupied by valid, current user-generated data.

The monitoring of data access and memory activity to determine namespace workloads allows the module controller 332, to generate and maintain a workload strategy that sets one or more workload trigger events that correspond with reactive and/or proactive alterations to current namespace operational policy. That is, a workload strategy can comprise a number of different workload trigger events, such as number of errors, available memory, volume of processing available, or number of memory cell accesses over time, that prompt the execution of one or more namespace operational policy alterations, as prescribed in the namespace strategy, to maintain, mitigate, or reduce the effects of workload volatility on namespace data access performance. The identification and control of namespace workloads allows the heat module 330 to optimize data access consistency and reliability while mitigating the generation of heat by altering how memory cells are utilized for data accesses.

The execution of one or more strategies generated by the namespace module 330 provides a balance of data access request satisfaction speed with heat generated and/or dissipated in a manner that meets a predetermined Quality of Service (QoS) standard, deterministic input/output window, or performance threshold. The ability to conduct memory cell operational policy changes with the various strategies while the workload strategy identifies and controls the workload actually experienced by assorted logical namespaces of a data storage system allows the heat module 330 to intelligently adapt to changing memory and data access activity to continually provide performance in accordance with predetermined expectations while reducing the amount of heat a data storage device produces and accumulates.

The generation of assorted aspects of the workload and other strategies can provide sophisticated reactions to encountered namespace workloads as well as proactive actions that mitigate degrading heat accumulation when conditions and/or activity change. The proactive generation of the workload and cooling strategies by the heat module 310 allows the module controller 332 to execute workload, namespace, and memory cell operation control actions quickly and efficiently once a workload trigger is reached. In contrast, purely reactive generation of namespace and/or memory cell operation manipulation actions by the namespace module 330 would involve additional processing and time to evaluate and generate the proper action(s) to establish workload control and provide continued namespace data access performance to satisfy one or more predetermined expectations. While the saving of processing overhead, the configuration of the respective workload and heat control strategies with both reactive and proactive actions provide intelligent long-term namespace and memory cell optimization that cannot be achieved with static operational policies or purely reactive generation of action(s) to control and optimize the operation of memory cells in view of workload.

The generation of proactive actions and identifying future workload and namespace operational performance for the respective strategies is aided by a prediction circuit 346. A prediction circuit 346 can input assorted current and past operations, actions, and activity, along with model data from other memory, to forecast at least one future namespace operational condition, data access request, or data access performance. The accurate prediction of memory, metadata, and namespace conditions along with data access performance allows the respective strategies generated by the heat module 330 to have namespace operational policy adaptations to mitigate, or completely avoid, a forecasted future operational occurrence of difference between read and write request satisfaction. The prediction circuit 346 can further forecast how long different strategy actions will take for varying system conditions, which allows the module 330 to quickly adjust between different namespace actions to provide a practical workload control and maintain namespace operational performance without unduly stalling or degrading overall data storage system performance.

FIG. 17 depicts an example workload detection procedure 350 that can be carried out in a data storage system via a heat module in accordance with various embodiments. Data accesses are tracked in step 352 by the heat module. As such, the heat module can track assorted data access metrics concurrently or sequentially. The overall time to service a data access request is logged by the heat module in step 354. It is noted that the overall time to satisfy a data access request is not the only activity tracked in 352, but such activity tracking can be prioritized by redundantly monitoring and interpreting the elapsed time from submission of a data access request by a host to the return of data, in the case of a read request, or the writing of data to a namespace, in the case of a write request.

The logged time to service a data access request can be evaluated in isolation or with the service times of other data access requests to a namespace to determine how long a new data access request to a namespace would take to service. As a result of the logging of actually completed data access requests in step 354 along with the association of new data access requests with an estimated time to service, the heat module can compile the workload for a namespace. That is, the combination of previously satisfied data access requests and estimated time to service new requests provides enough information for a heat module to determine the workload for a namespace. Hence, the heat module generates and maintains a workload value for each namespace that corresponds to how long a data access request takes to be satisfied. A namespace workload further corresponds to the memory cell operational performance of a namespace as well as the current channel and processor capabilities that service memory cells of a namespace.

With the logging of actual request satisfaction times in step 354 and the association of future requests with request satisfaction times in step 356, the heat module can compile workload values over time for each namespace of a device/system. The tracking of workloads to various namespaces allows the heat module to identify various workload patterns that reliably indicate future data access request satisfaction times, processing requirements, and buffer memory requirements in step 358. The combination of the determination of namespace workload and the association of workload patterns with future namespace time to satisfy a data access request provides ample information for the heat module to correlate current namespace workload with an impact to predetermined namespace operational performance and/or power consumption expectations in step 360, such as QoS, deterministic window, error rate, and average data access latency.

Through the tracking of workloads and correlation of those workloads with impact to predetermined namespace operational performance, the heat module can rank the various available namespaces in step 362 with the aid of the ranking circuit. Such namespace ranking can organize namespaces by availability, efficiency, reliability, read performance, or write performance. For instance, the heat module can rank namespaces in step 362 by which namespaces can service a request most quickly (availability), with least processing and/or power consumption (efficiency), with least error rate (reliability), read request latency, average request service time, or write request latency. The ranking of namespaces allows the heat module to generate and adjust cooling strategy policy actions that provide the greatest opportunity to satisfy performance expectations with mitigated accumulations of heat in view of current and future predicted namespace workloads.

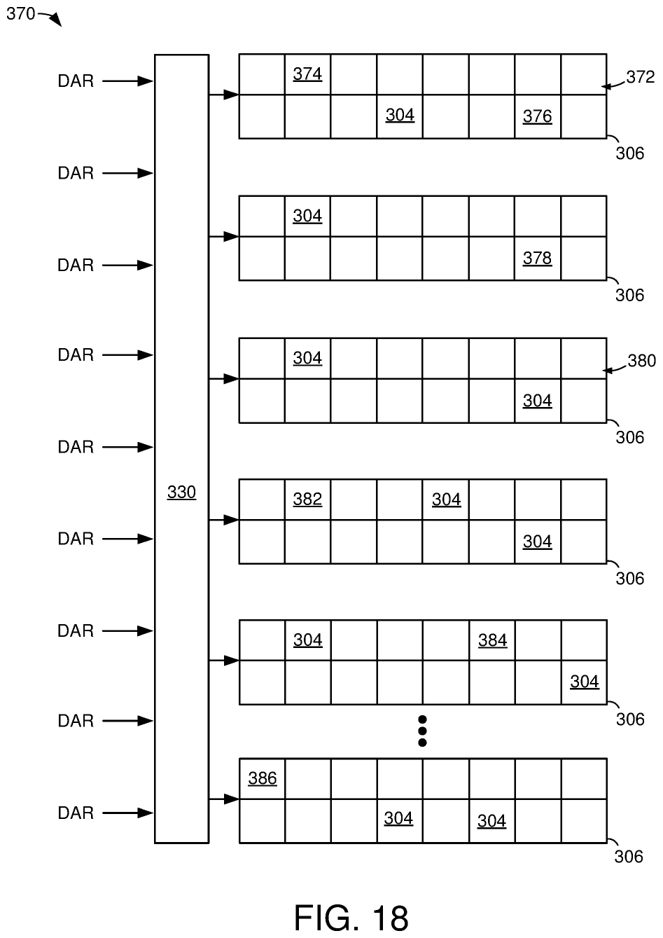

FIG. 18 depicts a block representation of portions of an example data system 370 in which assorted embodiments can be practiced. Any number of separate data storage devices, and memories, can be connected to a heat module 330 to carry out various data access requests and background operations. A controller of the heat module 310 can be local to a data storage device, such as physically positioned within a data storage device housing, or remote to the device, such as external to a device housing. The controller can schedule, execute, and monitor a number of different data accesses to satisfy requests from a number of different remote hosts.

It is contemplated that the heat module 330 can generate and maintain one or more heat maps for the various physical and logical units of the system 370. For instance, the heat module 330 can log and track memory cell activity over time and associate assorted activities to a predetermined amount of heat along with a corresponding estimated heat dissipation gradient. The correlation of memory cell addresses to memory cell activity, generated heat, and retained heat over time allows the heat module to execute one or more actions of the active cooling and/or passive cooling strategies to alter operation of at least some memory cells to reduce the generation of heat and/or the dissipation of heat.

Through operation of the controller carrying out an active cooling strategy in response to one or more namespace workload triggers being met, or exceeded, various data accesses, and/or other memory cell activity, can be throttled to induce slower-than-possible performance to mitigate the generation of heat. A first namespace 372 illustrates how a first memory cell 374 can have a data write, data read, or background cell operation delayed by inserting a time delay. A second memory cell 376 can be throttled by altering channel, bus, interface, or other hardware operation to deliberately slow the execution of pending data accesses below an average, and peak, performance of the cell 376.

Various embodiments of the heat module 330 track and map the frequency of data accesses to various memory cells to understand where data is most frequently read, written, updated, error corrected, and moved. Such a map can complement a heat map and can be at a different granularity. For example, activity frequency map may have a granularity that tracks each physical block address while a heat map can have a granularity of per plane or die of memory. The ability to alter the granularity in which memory cell activity frequency and generated heat are tracked allows the heat module 330 to maintain a balance of the processing resources used to track activity to memory with the accuracy of understanding how much, and where, heat is present.

The tracking of memory cell activity can allow an active cooling strategy to move data between different portions of memory that have less access frequency and/or less accumulated heat, such as from one die to another or from one plane to another, as shown by the third memory cell 378. It is contemplated that redundant copies of data are concurrently written to different portions of memory, in accordance with a preexisting active cooling strategy, to allow the heat module 330 to satisfy a data read request from the colder portion of memory. Accurate tracking of both generated heat and memory cell activity allows the execution of active cooling strategy actions that have a greater efficiency of reducing heat, such as where, and how much, to throttle the data access performance of memory cells.

As conveyed in die 380, various memory cells 304 can conduct altered operation in accordance with an active cooling strategy by manipulating a bus speed and/or data access clock. The manipulation of operating speeds for buses, interfaces, and/or channels can either reduce or increase data access speed, which allows the heat module 330 to alter different portions of memory with reduced performance to control heat while other portions of memory have greater performance to provide balance and maintain an overall average system data access performance.

One or more memory cells, in some embodiments, have reduced heat production through the use of decreased reference voltages provided by the heat module 330 through the execution of an active cooling strategy. Some memory, such as the fourth memory cell 382, can be logically updated with a reduced reference voltage used to read data and/or may be written with a lower voltage that is associated with an altered logical demarcation between logical states. Regardless of how a reduced reference voltage is utilized, the use of lower amounts of electricity to access a memory cell can effectively mitigate the generation of heat without degrading the speed, reliability, or security of data. However, such reduced reference voltage utilization can correspond with increased error rates as the separation between logical states can be narrowed. Hence, the altered reference voltage can be temporary and correlated to the amount of heat and the workload of portions of memory.

In addition to, or as an alternative to, the execution of an active cooling strategy, a passive cooling strategy can alter one or more data access parameters for existing data. As non-limiting examples, a fifth memory cell 384 can be assigned a reduced refresh rate by the heat module 330 and a sixth memory cell 386 can be supplemented with additional metadata, error correction code, compression, and/or encryption to slow future data accesses to the cell 386. The execution of the passive cooling strategy can involve other actions that deliberately reduce the performance, speed, and heat generated in the service of data access requests from hosts.

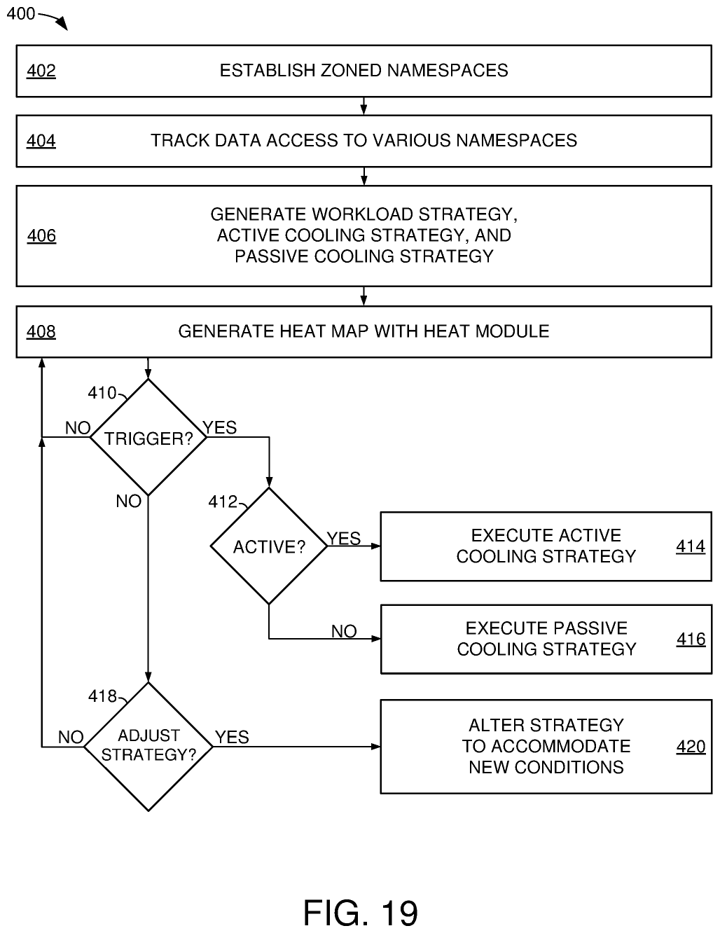

FIG. 19 conveys an example workload-based memory temperature routine 400 that can be carried out with the assorted embodiments of FIGS. 1-19 to control the generation and dissipation of heat proximal solid-state memory cells. Connection of a heat module to a memory, such as a solid-state data storage device, allows for the initialization of the memory to service data access requests from hosts external to the memory, such as a third-party user. The heat module may oversee, or dictate, the establishment of zoned namespaces in step 402 that can occupy any physical and logical data block addresses in one or more data storage devices, die of memory cells, and planes of memory cells. Activity to the zoned namespaces established in step 402 is subsequently tracked in step 404 by the heat module to determine the capabilities, current performance, and operational configuration of the memory cells of the assorted namespaces. It is noted that the heat module can track any number of different data access and memory behavior metrics over time.

The tracked data access activity and memory characteristics compiled by the heat module from step 404 allows the heat module to assign workload values to the respective namespaces that correspond with at least the volume of data accesses conducted on a namespace for a given length of time. An assigned namespace workload value may be more sophisticated, as directed by the metadata module, and can include a compilation of memory cell efficiency and/or reliability with availability. The ability to adapt the tracking of activity for a namespace and the generation of a workload value for the namespace allows the heat module to conduct more, or less, rigorous processing and time to determine how much capability of a namespace is occupied by data access operations initiated by external hosts as well as background memory operations, such as garbage collection, memory refresh, and data mapping.

The generated workloads are monitored over time by the heat module while a workload strategy is generated in step 406. The workload strategy establishes when various namespaces can benefit from reactive and/or proactive operational metadata policy changes that provide data access performance manipulation and sets a workload trigger to prompt execution of at least one memory cell operational policy change action as prescribed by an active cooling strategy or a passive cooling strategy generated in step 406.

Next, step 408 correlates data access tracked in step 404 with at least a heat map that describes the volume and location of heat in the form of elevated air, memory cell, and/or data storage device component temperatures. The heat map may be generated alone or in combination with a data access frequency map that describes which memory cells are being accessed most frequently. It is noted that the heat map and access frequency map may be at different granularities and contain different information due to some data accesses generating more heat than others.

The presence of strategies that prescribe actions to mitigate heat allows decision 410 to evaluate if there is any indication that a triggering event will transpire, such as in predetermined workload triggers, detected volumes of heat, and/or predicted memory temperatures. With no triggering event present, routine 400 returns to step 408 where data access are tracked and logged to generate one or more maps describing data access activity and/or generated heat over time. If a triggering event is detected, or predicted, decision 412 evaluates if active or passive cooling actions are to be conducted to mitigate the accumulation of heat. The heat module may evaluate, in decision 412, the pending data access requests, current performance of various memory cells, and/or error rates to determine how much processing, time, power, and buffer memory space to utilize.

If active cooling is determined to be the proper response to the triggering event, step 414 executes one or more prescribed actions. However, if less system resources are available, and/or active actions would jeopardize the ability of a memory to satisfy a guaranteed window of performance, step 416 executes one or more actions prescribed by the passive cooling strategy. It is contemplated, but not required, that a heat module can execute multiple different actions from the passive and active cooling strategies concurrently or sequentially.

At any time, the heat module can evaluate if the existing cooling and/or workload strategies are optimal for the current memory and/or data access activity. Decision 418 assesses if a change to one or more existing strategies can improve the efficiency and/or effectiveness of heat mitigation in a memory. Step 420 proceeds to alter at least one action of at least one strategy, as directed by the heat module, to optimize the prescribed strategy actions to the current, and predicted, memory conditions and activity. For instance, step 420 can change the manner in which data accesses are throttled, where data is moved, the clock speed used, the channel assigned to a data access request, and a reference voltage for one or more memory cells.

With the intelligent utilization of a heat module in accordance with assorted embodiments, operating conditions of a memory can be altered while remaining active to reduce the amount of heat generated and/or increase the dissipation of existing heat. The lack of convective cooling means, such as a fan or heatsinks, in a solid-state data storage device can be overcome by generating, maintaining, and executing active and/or passive cooling actions that change how memory cells operate and/or are accessed. The correlation of data access frequency and generated heat to actual, pending, and predicted namespace workloads allows the heat module to conduct proactive and reactive actions to reduce the amount of heat generated during the satisfaction of various data access requests.

What is claimed is:

1. A method comprising:
arranging a plurality of memory cells into a plurality of logical namespaces, each logical namespace of the plurality of logical namespaces sequentially written and entirely erased as a single unit;
logging data access activity to the plurality of memory cells with a heat module;
determining a workload to at least one namespace;
creating an active heat strategy with the heat module in view of the at least one namespace workload; and
altering an active data access operational policy for a first namespace in response to detection of a workload trigger.

2. The method of claim 1, wherein the active data access operational policy is a clock speed.

3. The method of claim 1, wherein the active data access operational policy is a reference voltage for at least one memory cell of the first namespace.

4. The method of claim 1, wherein the active data access operational policy is an assigned channel connecting a host to the first namespace.

5. The method of claim 4, wherein the assigned channel is slower than an original channel connecting the host to the first namespace.

6. The method of claim 1, wherein the active data access operational policy is an queued list of data access requests to the first namespace.

7. The method of claim 1, wherein the active data access operational policy is a destination physical block address in the first namespace.

8. The method of claim 1, wherein the active data access operational policy is a data access speed.

9. The method of claim 1, wherein the active data access operational policy is altered to write data to the first namespace sequentially.

10. The method of claim 1, wherein the active data access operational policy is altered to write data in with throttled performance that is less than a maximum performance for the first namespace.

11. The method of claim 1, wherein the active data access operational policy is altered to provide at least a threshold data access performance to satisfy a Quality of Service agreement with a minimal amount of heat produced by the first namespace.

12. A method comprising:
arranging a plurality of memory cells into a plurality of logical namespaces, each logical namespace of the plurality of logical namespaces sequentially written and entirely erased as a single unit;
logging data access activity to the plurality of memory cells with a heat module;
determining a workload to at least one namespace;
creating a passive heat strategy with the heat module in view of the at least one namespace workload; and
altering a passive data access operational policy for a first namespace in response to detection of a workload trigger for the first namespace.

13. The method of claim 12, wherein the passive data access operational policy is an error correction code.

14. The method of claim 12, wherein the passive data access operational policy is a refresh rate for at least one memory cell of the first namespace.

15. The method of claim 12, wherein the passive data access operational policy is a background operation schedule for the first namespace.

16. A method comprising:
arranging a plurality of memory cells into a plurality of logical namespaces, each logical namespace of the plurality of logical namespaces sequentially written and entirely erased as a single unit;
logging data access activity to the plurality of memory cells with a heat module;
determining a workload to at least one namespace;
creating an active heat strategy and a passive heat strategy with the heat module in view of the at least one namespace workload;
altering an active data access operational policy for a first namespace in response to a workload trigger for the first namespace being met; and
altering a passive data access operational policy for a second namespace in response to prediction of a workload trigger for the second namespace.

17. The method of claim 16, wherein the active data access operational policy is chosen based on a predicted workload for the first namespace.

18. The method of claim 16, wherein the active data access operational policy is chosen based on a detected workload for the first namespace.

19. The method of claim 16, wherein the heat module alters a granularity of temperature tracking in the second namespace during the execution of the passive heat strategy.

20. The method of claim 16, wherein the active heat strategy is executed on the first namespace in response to the first namespace being ranked by the heat module as having the greatest power consumption of the plurality of logical namespaces.
